(19) United States
(12) Patent Application Publication
(10) Pub. No.: US 2013/0082101 A1
(43) Pub. Date: Apr. 4, 2013

(54) SYSTEM AND METHOD FOR FIELD MANAGEMENT USING BARCODES AND OPTICAL SCANNERS

(71) Applicants: Adam H. Omansky, Charlestown, MA (US); Joshua L. Kanner, Cambridge, MA (US)

(72) Inventors: Adam H. Omansky, Charlestown, MA (US); Joshua L. Kanner, Cambridge, MA (US)

(73) Assignee: Vela Systems, Inc., Burlington, MA (US)

(21) Appl. No.: 13/249,645

(22) Filed: Sep. 30, 2011

(51) Int. Cl. G06F 17/00

(52) U.S. Cl. 235/376

(57) ABSTRACT

The invention generally relates to system and method for field management using barcodes and optical scanners.

### FIELD OF THE INVENTION

The invention generally relates to system and method for field management using barcodes and optical scanners.

### BACKGROUND

A strategic closeout process is involved in the success of any construction or capital project. In general, a disproportionate amount of time and cost is required to produce relatively marginal progress toward perfection, as a measurable degree of quality, in both the current standard and non-standard project delivery methods. Time and cost expenditures, to address quality control during the construction process and closeout phases, can be a balance between the disparate interests of the stakeholders and related parties: owners, developers, capital partners and equity investors, operators, architects, consulting engineers, contractors, sub-contractors, vendors, etc. Attaining the quality established in the contract documents, and demanded by the architect, consulting engineers, and other designers, can jeopardize both the schedule and the budget.

The current, industry-standard quality control and closeout workflow process, in general, provides that stakeholders employ manual means and methods during the quality control and closeout process. In one example, stakeholders inspect the work and generate issue lists and related reports and protocols by hand, using traditional paper and pen, a laptop, or tape recorder or digital audio recording device. Administrators transfer the data and meta-data, from the in-situ inspections to a paper or electronic document, usually a spreadsheet. In most projects each stakeholder, including the general contractor, sub-contractors, architect, and consulting engineers, manages a separate document, distinct and insulated from the other parties. The result: a non-productive working environment, plagued by wasted expenditures of time and energy, and increased stress and strife. The accuracy and integrity of information is often neither dependable nor verifiable at any given moment in time.

### SUMMARY

Embodiments of the present invention may be used in a wide variety of field administration applications, e.g. those involving the tracking of issues and one or more levels of review or approval in the closure of the issues. Examples of construction projects include, but are not limited to: the construction and capital project areas such as commercial buildings, residential buildings, non-residential buildings, non-building structures, such as marine, off-shore, power, and process industry segments; safety inspections; facility maintenance and various observation and inspection tasks, start-up activities, pre-commissioning, commissioning, testing, adjusting, balancing, operations, maintenance, service, repair and turnaround of work.

According to one illustrative embodiment of the invention, a system for field administration of a construction project includes a barcode adapted to be affixed to at least one physical component of the project, the physical component having at least one deficiency. An optical scanner is provided for scanning the barcode. A storage device stores an issue list. The issue list includes at least one work item corresponding to the physical component of the project on which the barcode is affixed. A first user interface enables a first party to view the at least one work item and indicate completion of an activity corresponding to the at least one work item, thereby signifying closure of the at least one work item. A second user interface enables a second party to view a status of the at least one work item and accept or reject the closure of the at least one work item.

In another illustrative embodiment of the invention, a method of field administration of a project is provided. The method includes the acts of affixing a barcode having an identifier to a physical component of the project having at least one deficiency and corresponding to at least one work item. The barcode is scanned by an optical scanner device, allowing the identifier to be received at a first mobile computing device. Information associated with the identifier is input into the first mobile computing device relating to a deficiency in the physical component. The information and the identifier are transmitted from the first mobile computing device to a storage device. The information and identifier are stored in the storage device.

The stored information can be transmitted to a second mobile computing device. Thus methods of the invention further involve receiving the information and the identifier from the storage device at a second mobile computing device after the first mobile computing device transmits the information and the identifier to the storage device. The identifier and an indication that the deficiency has been corrected is transmitted to the storage device from the second mobile computing device, and also transmitted to a third mobile computing device. Additionally, the identifier and an indication that correction of the deficiency has been accepted or rejected is transmitted from the third mobile computing device back to the storage device, which results in the storage device being updated to reflect the acceptance or rejection of the correction of the deficiency.

According to a further illustrative embodiment of the invention, another method of field administration of a project is provided. In this method, a plurality of barcodes, each having a unique identifier, are affixed to a plurality of physical components of the project. Each barcode is capable of transmitting a unique identifier. The barcodes are scanned by an optical scanning device, resulting in transmission of the unique identifiers to a mobile computing device. Information relating to the physical component of the project and associated with the at least one unique identifier is received from a stationary storage device. The information is displayed on the first mobile computing device, allowing a user of the first device to indicate a deficiency in a physical component of the project. A second mobile computing device is allowed to view the information and accept or reject the deficiency after the first mobile computing device indicates the deficiency in the physical component of the facility, such that upon an acceptance or rejection of the deficiency by the second mobile computing device, the stationary storage device is updated to reflect the acceptance or rejection of the deficiency in the physical component of the facility.

According to another embodiment of the invention, a method is provided including the acts of associating an identifier of a barcode to a physical component of a project and creating a work item on an issue list. The work item is associated with the identifier and related to a deficiency in the physical component. A first comment corresponding to the work item is input. The first comment is associated with the identifier. The method also includes displaying the first comment in relation to an inquiry pertaining to the identifier.

### BRIEF DESCRIPTION OF THE DRAWINGS

The invention will be apparent from the description herein and the accompanying drawings.

FIG. 1 is a schematic illustration of an exemplary implementation of an embodiment to the present invention.

FIG. 2 is a schematic illustration of an illustrative embodiment of a system for field administration of a project, according to an illustrative embodiment of the invention.

FIG. 3 illustrates a method of field administration of a project according to an illustrative embodiment of the invention.

FIG. 4 illustrates another embodiment of a method of field administration of a project according to the invention.

FIG. 5 illustrates another embodiment of a method of field administration of a project according to the invention.

FIG. 6 illustrates a screen shot of a graphical user interface according to an embodiment of the invention.

### DETAILED DESCRIPTION

According to various embodiments of the invention, barcodes and optical scanners are used to uniquely identify various project components and may be used with an issue list located on a storage device to provide an inventory of the deficiencies of the project components, which may be described as physical work to be completed and/or corrected. Various embodiments of the invention may create static and/or dynamic information links, between the deficiencies and an extranet or shared database, via wireless connections and/or wired connections. The invention's use of barcode and optical scanner technology may streamline the project quality control, closeout, and lifecycle process, in the best interests of project stakeholders.

According to an example of the invention, during a field inspection, the contractor, sub-contractor, architect, consulting engineer, or other party identifies a deficient component of the project, obtains a barcode having a unique identifier with a receiver, such as a mobile computing device, and adheres the barcode to the physical object. One barcode can relate to one deficiency, or one room or one area with multiple deficiencies, depending on the need. An optical scanner is used to scan the barcode and communicate its information to the mobile computing device, which communicates the data about the deficient work to an issue list on a storage device accessible to all of the connected parties, either on or off site. The issue list itself may become live and direct, an active force to propel the quality control and closeout process. Various embodiments of the invention may transform the issue list to an integrated networking technology. When the sub-contractor or vendor addresses the deficiency, the issue list is updated by the use of the barcode as a reference to the deficiency.

The standard contract closeout inspection procedure is congested with layers of formal invitations, inspections, document transmissions, and related protocols. Various embodiments of the invention may change the workflow, from a linear, sequential process to parallel, simultaneous workflow. By way of contrast, a typical project closeout process may be as follows.

On some projects with a high budget and/or a high cost of construction, and with a high degree of complexity and/or non-standard means and methods of construction, such as a mega-hotel or mixed-use complex for example, the issue list can contain thousands to tens of thousands of items of work. Management and implementation of the thousands of items of work, in cooperation with the sub-contractors and the vendors, and in strict accordance with the contract documents, can require months of time, at a phase in the project when the stakeholders can least afford any delays. To complicate matters, the plethora of work in the quality control and closeout phase resides in the details, which can be very laborious to locate and to track. When the issue list item requires work by multiple sub-contractors and/or vendors, the general contractor can face major problems to recall the trades back to the project site, to coordinate and to sequence the execution of the work in a timely manner, and to verify the work when completed or corrected; accountability can be very problematic in areas with multiple trades.

When presented with the tradeoff between compliance with the schedule or the standard of quality, the owner, in the majority of cases, sacrifices quality in favor of time. Relinquishing selected contractual rights, as part of a negotiated, pre-handover settlement, is not uncommon in complex, modern-day projects. In return for an agreement to compromise on quality, the owner deducts a pre-determined or a negotiated sum of money from the contractor's fee. The contractor needs to finish the job, and the owner needs to occupy and to use the space for its intended use. Neither party is interested in engaging first in mediation, second in formal arbitration, and third in adjudication or litigation.

The owner and architect sacrifice quality, and the contractor suffers a reduction in fee. End-game tradeoff negotiations can instigate disputes, at a period when cooperation and collaboration, not conflict, is important. Focus shifts to non-constructive activities, and to re-negotiation of the general contract. Focus should be on the construction work. If not well-managed, a project with a sound start and a fluid construction process can fail in the end-game. In practice, the standard contract closeout process does not always support the interests of the stakeholders, in particular when financial sustenance and reputation is at stake.

With the ever-increasing complexity of modern-day projects, thousands of issue list items significantly impede the momentum of the work, in the end-phase of the job, between substantial completion and final acceptance of the contract. Final acceptance is the stage in the contract when the contracting officer determines that all work has been 100 percent completed according to the terms and conditions of the contract documents, including administrative obligations. As the contractor is at the peak of the learning curve, toward the end of the project, in theory, the remaining 5% or thereabouts of the work will take proportionately less time to execute. In practice however, the remaining 5% to 10% or thereabouts of the work can require significantly more time, jeopardizing deadlines. The subsequent handover to and final acceptance by the owner, operators and other end-users can be compromised. If the project team misses the final acceptance deadline, the contractor can incur severe liquidated damages, payable to the owner. The owner can suffer a loss of revenue from a lack of operations, penalties from commercial banks and other lending institutions, and perhaps scandal from shareholders and the general public.

As a legal record, the substantial completion inspection list functions as the means and method to communicate all items to be completed and corrected, before the owner, owner's agent, architect or other contracting officer can accept the work as 100% complete. Final acceptance entitles the contracting officer to issue the final certificate for payment, co-signed by the architect, contractor and owner. Final payment, plus hold-backs by the owner, motivates the contractor to complete the final work, often about 5% or thereabouts, depending on the conditions of the project.

When the issue list inspection process is completed by the contractor, sub-contractors, and the architect, the parties acknowledge in writing that the work is substantially complete. The contractor agrees in writing to complete and correct all outstanding work. Accordingly, the owner agrees in writing to assume full possession of the work, or designated portion thereof. Depending on the conditions of the contract for construction, the contractor may transfer responsibility for security, maintenance, and insurance to the owner. Parties sign-off on the date of substantial completion of the project, and applicable warranties commence, as required by the contract documents.

Attached to the certificate of substantial completion, the issue list quantifies the outstanding physical work, in a legal format, for short-term use and long-term record. By defining the scope of the outstanding work for the sub-trades, the issue list benefits the contractor. In high-liability projects, such as condominiums where individual owners demand a high standard of quality, the issue list helps to protect against future litigation. Serving future owners, the issue list also acts as the vehicle to help ensure that the contractor delivers the degree of quality established in the contract documents. Supplementary to the certificate of substantial completion, the issue list provides a checks-and-balances system to the final 5% to 10%, or thereabouts, of the project delivery process, with respect to the distinct interests of all of the stakeholders and other project parties.

The project closeout period, between the dates of substantial completion and final acceptance, presents legal obligations for both the contractor and the owner. Between substantial completion and final acceptance, the contractor demobilizes or “ramps down,” and the owner mobilizes or “ramps up.” The owner and the contractor simultaneously occupy the space, which sometimes instigates conflict. The owner has the right to utilize the space for its intended use, as the contractor completes the issue list work prior to final acceptance. The owner and contractor may use the changeover period to train the owner's facility manager in general operations. Contracts can also call for the demonstration to and the training of the owner's personnel, in the operation, adjustment, and maintenance of products, equipment, and systems, as a pre-requisite of substantial completion.

Submitting a final application for payment reaffirms the due date for handover in accordance with the contract, and the respective obligations between the owner and the contractor. The contractor may also be required to submit: evidence that all record documents, operation and maintenance manuals, warranties and similar required submittals are approved; final sub-contractor payment forms; evidence of final, continuing insurance coverage; record as-built contract schedule; warranty book; etc. Before the contractor can request the final inspection, to determine the date of final acceptance, the contractor needs to submit a certified copy of the substantial completion inspection list or issue list, endorsed and dated by the contracting officer or architect. As the end-date for any liquidated damages, final acceptance is crucial to control the contractor's exposure, as responsibility transitions to the owner. At final acceptance, insurance or risk of loss shifts from the contractor to the owner. The warranty period starts. Time limitations begin for an action on a bond, for the filing of a mechanic's lien, and for exposure under statutes of limitations and repose. The issue list becomes the essential “driver” of the end-game, as events hinge upon the completion, and the subsequent certification of completion of the physical work.

According to an illustrative implementation 100 of the embodiment of the invention, one or more barcodes 110 are each located on a corresponding physical component of a project. The barcodes 110 may be affixed to the component of the project because the component is somehow deficient. The terms “deficient” and “deficiency” as used herein, refer to a component in need of additional work or other remedial action or inspection, e.g., a non-conforming issue or conforming observation. As used herein, the term “affixed” is meant to designate a wide variety of actions whereby the barcode 110 is co-located with the component. Examples include mounting the barcode 110 by an adhesive, a removable fastener, such as a hook and loop fastener, a physical fastener, such as a nail, screw, or rivet, or simply positioning the barcode 110 proximate to the physical component of the project.

A barcode is an optical machine-readable representation of data, which shows data about the object to which it attaches. Any type of barcode may be used with systems and methods of the invention. For example, the barcodes may represent data by varying the width and spacing of parallel lines, referred to as linear or 1 dimensional (1D) barcodes. Alternatively, the barcodes may represent as rectangles, dots, hexagons and other geometric patterns in 2 dimensions (2D), i.e., 2D barcodes. Barcodes of the invention are compatible with any optical scanner known in the art, for example barcode readers or devices including desktop printers, tablet computers (e.g., Ipad) and smart phones (e.g., Iphone and Blackberry) that include interpretive software.

The mapping between messages and barcodes is called a symbology. The specification of a symbology includes the encoding of the single digits/characters of the message as well as the start and stop markers into bars and space, the size of the quiet zone required to be before and after the barcode as well as the computation of a checksum. Linear symbologies can be classified mainly by two properties: continuous vs. discrete and two-width vs. many-width. Characters in continuous symbologies usually abut, with one character ending with a space and the next beginning with a bar, or vice versa. Characters in discrete symbologies begin and end with bars; the intercharacter space is ignored, as long as it is not wide enough to look like the code ends. Bars and spaces in two-width symbologies are wide or narrow; the exact width of a wide bar has no significance as long as the symbology requirements for wide bars are adhered to (usually two to three times wider than a narrow bar). Bars and spaces in many-width symbologies are all multiples of a basic width called the module; most such codes use four widths of 1, 2, 3 and 4 modules.

Some symbologies use interleaving. The first character is encoded using black bars of varying width. The second character is then encoded, by varying the width of the white spaces between these bars. Thus characters are encoded in pairs over the same section of the barcode. Interleaved 2 of 5 is an example of this. Stacked symbologies repeat a given linear symbology vertically. The most common among the many 2D symbologies are matrix codes, which feature square or dot-shaped modules arranged on a grid pattern. 2-D symbologies also come in circular and other patterns and may employ steganography, hiding modules within an image (for example, DataGlyphs).

Generally, linear symbologies are optimized for laser scanners, which sweep a light beam across the barcode in a straight line, reading a slice of the barcode light-dark patterns. Stacked symbologies are also optimized for laser scanning, with the laser making multiple passes across the barcode. More recently, charge coupled device (CCD) imagers have been used to read barcodes. Imaging does not require moving parts, like a laser scanner does. 2-D symbologies cannot be read by a laser as there is typically no sweep pattern that can encompass the entire symbol. These barcodes must be scanned by an image-based scanner employing a CCD or other digital camera sensor technology.

Symbology for linear barcodes is continuous or discrete. Exemplary symbology for linear barcodes include: U.P.C.; Code 35—Non-interleaved 2 of 5; Code 39; Code 93; Code 128; Code 128A; Code 128B; Code 128C; CPC Binary; DUN 14; GS1 DataBar; and MSI.

Exemplary symbology for matrix barcodes (2D barcodes or 2D code) include: 3-DI; ArrayTag; Aztec Code; Smaa Aztex Code; Chromatic Alphabet; Codablock; Code 16K; Code 49; ColorCode; Compact Matrix Code; CP Code; CyberCode; d-touch; DataGlyphs; Data Matrix; Datastrip Code; Dot Code A; EZcode; Grid Matrix Code; High Capacity Color Barcode; HueCode; INTACTA.CODE; JAGTAG; mCode; MiniCode; MicroPDF417; MMCC; PaperDisk; PDF417; PDMark; QuickMark Code; SmartCode; Snowflake Code; ShotCode; SPARQCode; SuperCode; TrillCode; UltraCode; UnisCode; VeriCode (VSCode); and WaterCode.

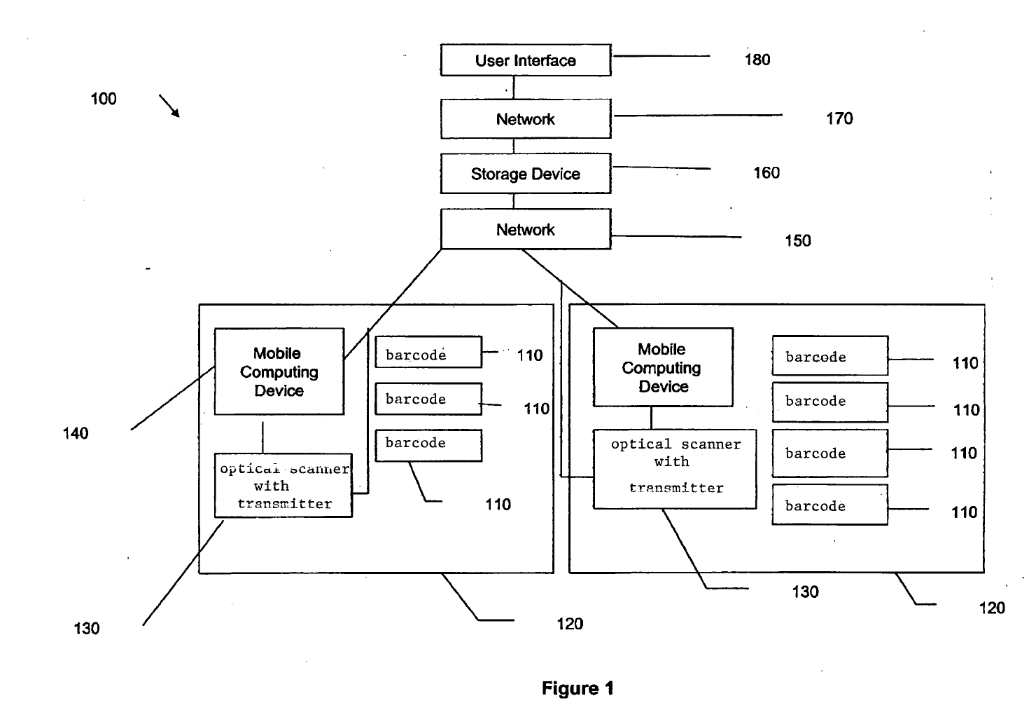

As illustrated in FIG. 1, one or more sites 120 may be used simultaneously within the scope of the invention. A site 120 may be geographically located adjacent to a near by site 120, or may be substantially geographically separated from other sites 120. One or more optical scanners 130 may be used on the site to scan the barcodes 110. The barcodes include a unique identifier such that the barcodes 110 being scanned can be distinguished from other barcodes by the use of the unique identifier. The optical scanner is a transceiver, capable of sending an interrogation signal to the barcodes 110. The optical scanner may have an integrated antenna or are coupled to an external antenna to enable transmission/reception as appropriate.

A mobile computing device 140 may also be used on the site 120. Examples of mobile computing devices may include, but are not limited to, a laptop, a tablet personal computer, a personal digital assistant, and a smart phone. Other examples of mobile computing devices include devices having a computer processing capability, an ability to communicate with a network, and a display and/or input capability for interaction with a mobile user. In the present example, the mobile computing device 140 can communicate with a network 150. Optionally, the optical scanner 130 may also communicate directly with the network 150, such as by the use of stationary receivers coupled to the network 150. Examples of communications may include, but are not limited to, a wireless network and a wired network, or combinations thereof. Examples of network 150 types include local area networks, such as for example, Ethernet, extranets, the Internet, Bluetooth and a wide variety of other networking protocols.

A storage device 160 is provided and configured to maintain an issue list. Examples of storage devices 160 include, but are not limited to computer servers, including those having processors and/or controllers, data storage devices such as hard drives or memory, or other devices capable of storing digital data and communicating with a network. The issue list includes the unique identifiers corresponding to the barcodes 110 and a wide variety of additional information that may be stored in association with the unique identifiers. It is understood that a wide variety of database or other memory management structures may be used within the skill in the art. Such structures may involve maintaining the unique identifiers in a separate table or structure from other information. Such structures are within the scope of the present invention. Multi-tenant computer architecture may also optionally be used, capable of supporting multiple projects concurrently while maintaining data security. In one example, the software may use standard username and password authentication via a web browser to determine the lists of projects and issues/defects that a given user may access. Therefore, each separate customer will have their own separate view of the data and not be able to access the data of other customers stored in the same database. In a further example, each customer will have a unique set of data within the shared database and each user within a customer will only have access to the information relevant to their company.

The information located on the storage device 160 in the present example would be directed toward the specifics of the physical component of the project upon which the barcode 110 is affixed. Examples of various attributes of the information include by way of example, but are not limited to:

### Multi-Party Field Identification

Example: PL-123.456.78
Primary auto-number: report number; PL (Defect or issue list) 123
Secondary number: room or area number; Room 456
Tertiary auto-number: sequential item number; Item 78

### Preface Metadata

Project name and project number
Date and time stamp of every revision on the issue
Focus area of the report; example: Fourth Floor Function Rooms
Status of the item, including open, new, closed, under review, reopen
Comments section with date/time stamp

### General Data or Content

Type of issue: Which may include plumbing, electrical, systems, finish or any other code in a selection list as outlined in the Subcontractor key attributes list below.
Severity of issue: Critical, Serious, Medium, Low
Priority of issue: High, Medium, Low
Notes; a brief description of the work to be completed or corrected
Responsible party: sub-contractor key
Repair code, if applicable, for repeat problems
Monetary value, assigned by the Contractor
Reasons why the work is not complete, indicated by the Contractor
Drawing or other contract document reference, if applicable
Specification division and sub-division reference, if applicable
Audio or other recording (photo, video) to establish record of what must be done

### Postscript Metadata

Author of the report
Signature by the Architect
Due date to complete the work, scheduled by the Contractor

### Acceptance Attributes

Actual date of completion
Signature of acceptance by the Contracting Officer, Owner's Agent, Project Manager, etc.
Signature of acceptance by the Architect
Signature of acceptance by the Contractor
Audio or other recording (photo, video) to establish record of what was completed

### Sub-Contractor Information to Establish Type of Work to be Conducted

A Sitework
   Earthwork/Footings
   Utilities/Sewerage/Drainage
   Waterproofing
   Paving/Landscaping
B Elevator/Stairs
C Structure
   Concrete
   Masonry
   Framing
   Metal work
D Roofing/Flashing
E Exterior Surfaces/Insulation
F Exterior Openings/Glazing
G Doors/Hardware
H Plumbing/Sprinkler
I Mechanical/HVAC
J Electrical
K Carpentry/Millwork
L Finishes
   Drywall
   Flooring
   Painting
   Specialties

In the present example, the mobile computing device 140 may contain a subset or a full set of the issue list stored of a storage device 160. In such a case, the mobile computing device 140 may operate locally, accepting inputs from a user and transmissions from the optical scanner 130. Periodically, the mobile computing device 140 could synchronize the data stored on the mobile computing device 140 with the issue list stored on the storage device 160. Other variations are within the scope of the invention, such as, by way of non-limiting example, a mobile computing device 140 that interacts directly with the issue list located on the storage device 160, updating the issue list upon receipt or inputting of the identifiers or information at the mobile computing device 140.

An optional network 170, which may be the same as the previously mentioned network 150, or may be a different network, provides for communication between the storage device 160 and an optional user interface 180. The user interface 180 may be a stationary user interface, providing interaction with the issue list located on the storage device 160 for those not located on the site 120, or for those users not located on the site for which they presently wish to obtain issue list information. The user interface 180 may be a graphical user interface or text-only or other some other type of user interface and may optionally include one or more input devices, such as a keyboard or mouse. The user interface 180 may also include an output device, such as a printer. Examples of users that may interact with the user interface 180 include, by way of non-limiting example, architects, construction managers, consulting engineers, contracting officers, designers, builders, general contractors, owners, owners' representatives, project managers, subcontractors, vendors, and IT specialists tasked with maintaining the implementation 100.

Information available from the user interface 180 and/or mobile computing device 140 may include, but is not limited to, reports, and other interactive views of existing issues and defects to monitor ongoing project status, attach comments, change statuses and otherwise provide management comment and oversight. Optionally, a download or export of the data may be provided from a given project into an external system in a file or report format. The user interface may optionally be multi-lingual.

According to an example, an embodiment of the invention may provide an interactive functionality to allow users to provide comments, and view comments by others, regarding a specific component of the project. The comments, as noted above, may be provided with a date/time stamp and may optionally include text, audio or other recording (photo, video). While not limited to these examples, the comments can be a brief description of the work to be completed or corrected, reasons why the work is not complete, recording to establish a record of what must be done and/or a record of what was completed. Use of the barcode associated with both the project component and each of the comments can provide a powerful organizational tool, enabling a wide variety of parties to have input to the process of defining/describing the work items and the process of working on and resolving the work items, regardless of where the parties are located. According to the example, the parties can communicate regarding a large number of project components, even though the parties may not be near the project component, or even on the work site, at the same time. Communication can be in the form of a real-time conversation through the use of the comments, or by the posting of comments by one party and the reply through later comments posted by another party.

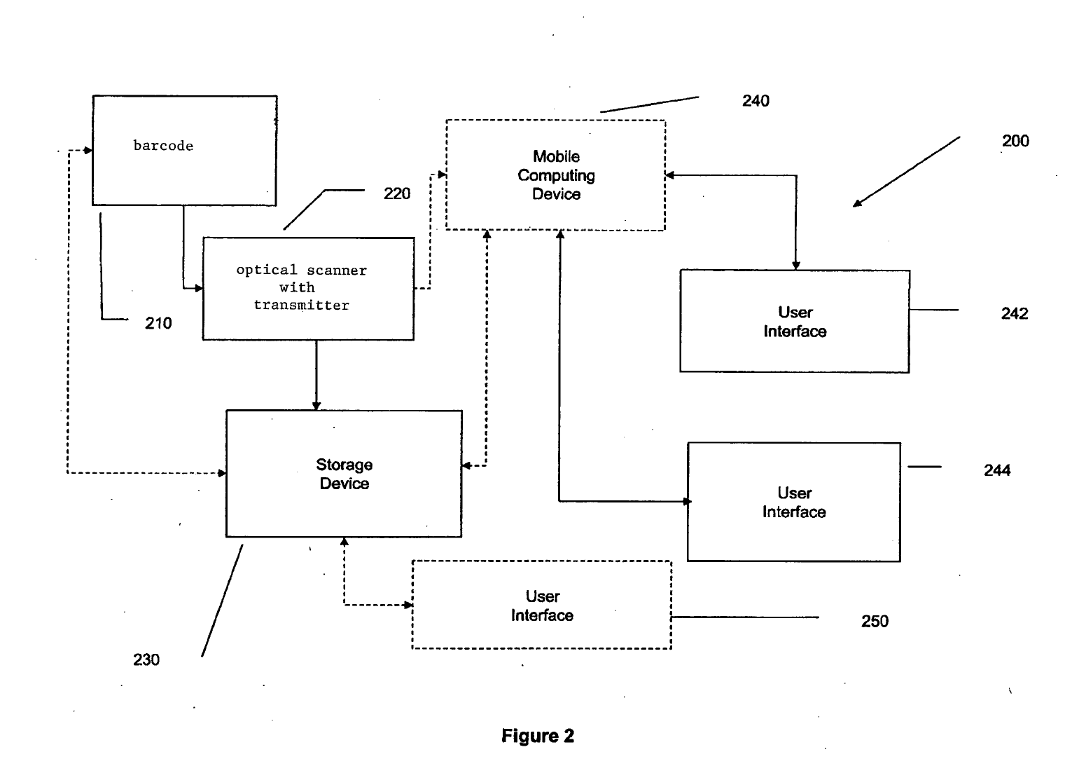

As illustrated in FIG. 2, a system 200 is illustrated by way of example according to an embodiment of the invention. The system 200 can be used for field administration of a project. The system 200 includes one or more barcodes 210. As described above in relation to FIG. 1, a barcode is provided with a unique identifier and is capable of transmitting the unique identifier via the optical scanner. The optical scanner includes a transmitter to transmit the information from the barcode to a receiver in the storage device 230. The storage device 230 is configured for storing an issue list. The issue list, as discussed above in relation FIG. 1, may include details regarding one or more physical components of the project. The information in the issue list is configured so that the information pertaining to a particular component of the project correspond to the unique identifier of the barcode 210 that is affixed to that component. A mobile computing device may optionally be provided for communication with the storage device 230. The mobile computing device 240 may optionally provide one or more user interfaces 242, 244 to display information and/or receive information input by user. Such information may relate to a wide variety of items, such as the issue list located on the storage device 230, data located on the mobile computing device 240 but not yet transmitted to the issue list of the storage device 230 and/or unique identifiers or other information corresponding to the physical objects of the project, the barcode 210.

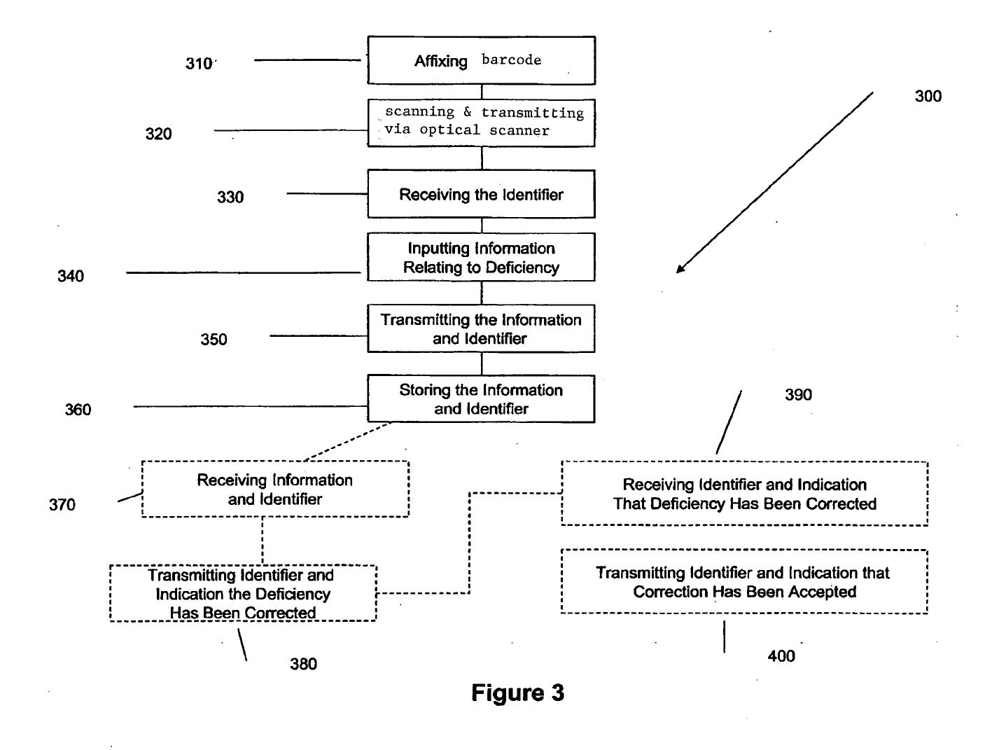

As illustrated by way of example in FIG. 3, a method 300 of field administration of a project is illustrated by way of example. A barcode is affixed 310 to a physical component of the project. The barcode has an identifier so as to distinguish it from other barcodes. The barcode is scanned by the optical scanner and the identifier is transmitted 320 from the optical scanner. The identifier is received 330 at a first mobile computing device. By way of example, the first mobile computing device may be used by an architect, engineer or other person responsible for inspection of the project and/or insuring quality control of the project.

Information is input 340 into the first mobile computing device. The information relates to a deficiency in the physical component of the project and is associated with the identifier of the barcode that is affixed to the physical component of the project. The information and identifier are transmitted from the first mobile computing device to a storage device. The information and identifier are stored 360 in the storage device.

Optionally, the information and identifier may be received 370 at a second mobile computing device. The identifier and an indication that the deficiency has been corrected may be transmitted 380 to the storage device from the second mobile computing device. By way of example, the second mobile computing device may be used by a worker that is mending or addressing the deficiency of the physical object of the project.

Further optionally, the identifier and the indication that the deficiency has been corrected may be received 390 at a third mobile computing device. The identifier and an indication that the correction of the deficiency has been accepted may be transmitted 400 from the third mobile computing device. The third mobile computing device may, for example, be used by a user responsible for inspecting work done to mend previously identified deficiencies, such as a supervisor, an owner, and/or a person responsible for quality control of the project.

It is within the scope of the invention that the first, second and third mobile computing devices may be a single piece of hardware. By way of example, a single tablet personal computer could be used by two or three different parties, such as for example an architect, a worker and later an owner or other final approval authority. Optionally, the mobile computing device may provide for different login or other authentication procedures so as to confirm the identity of the user thereby preventing improper or unauthorized entries by an inappropriate user. In other implementations, more than one mobile computing device may be used, including when each party has their own mobile computing device.

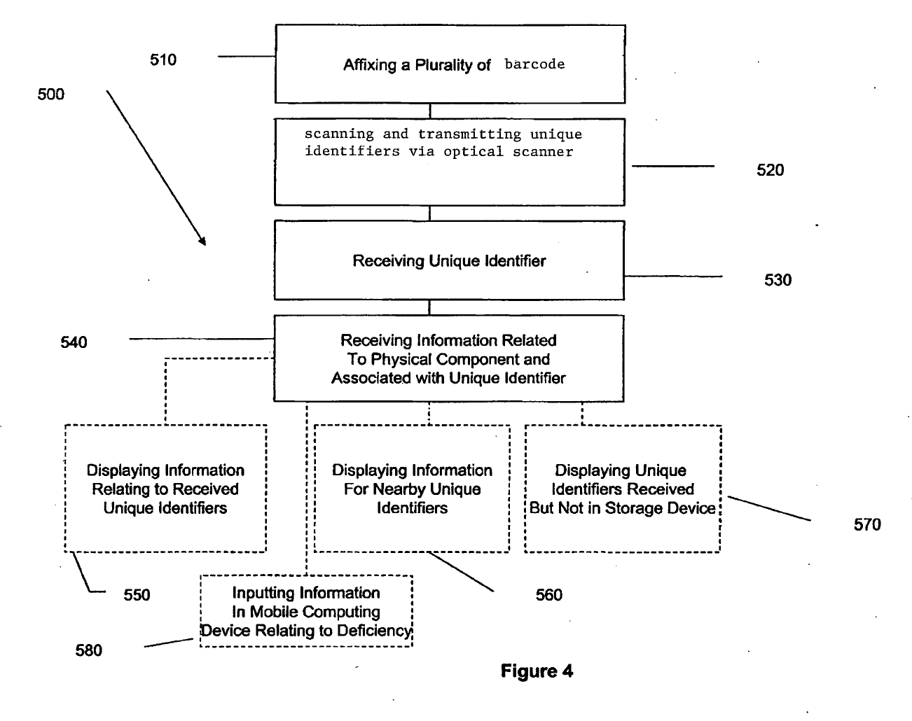

FIG. 4 provides an illustration of a method 500 for field administration of a project according to another illustrative embodiment of the invention. According to this method 500, a plurality of barcodes are affixed 510 to a plurality of physical components of the project. Each barcode has a unique identifier and is capable of transmitting the unique identifier. The barcodes are scanned by an optical scanner, which transmits 520 the unique identifier from at least one of the barcodes. It is understood that the scanning of the barcode and even transmission of the identifier associated with the barcode may occur before the barcode is initially affixed to the physical component of the project. The unique identifier is received 530 at a first mobile computing device. It is understood that a mobile computing device may optionally include a receiver and/or may receive the identifier via an external receiver in communication with the mobile computing device. Information relating to the physical component of the project and associated with the unique identifier is received 540 from a stationary storage device.

Optionally, the method 500 may also include displaying 550 information relating to each of the unique identifiers received at the first mobile computing device. In this example, the information is displayed on the mobile computing device. In one example, a user may enter a given location via an input device on the mobile computing device and/or a user interface and access the list of all current issues and defects for that location as based on the issue list.

In an optional variation, information may be input 580 into the first mobile computing device. The information may relate to a deficiency in the physical component of the project and associated with the identifier corresponding to the physical component of the project.

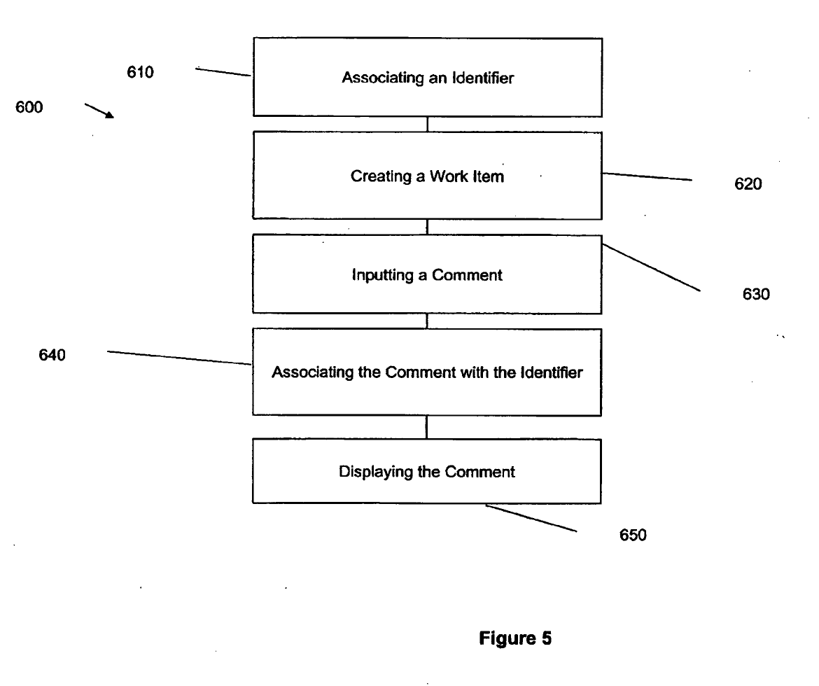

FIG. 5 provides an illustration of another embodiment of the invention. The method 600 includes associating 610 an identifier of a barcode to a physical component of the project and creating 620 a work item on an issue list. The work item is associated with the identifier and related to a deficiency in the physical component. A first comment corresponding to the work item is input 630. The first comment is associated 640 with the identifier. The method also includes displaying 650 the first comment in relation to an inquiry pertaining to the identifier.

The method optionally further includes, after the act of inputting, scanning the barcode with an optical scanner and transmitting the identifier and the first comment from a first mobile computing device to a storage device. Also, before the act of displaying, transmitting the identifier and the first comment from the storage device to a second mobile computing device.

The method may optionally include inputting a second comment corresponding to the work item and associating the second comment with the identifier. In this example, the first comment and the second comment are displayed in relation to an inquiry pertaining to the identifier.

The method may optionally include the act of affixing the barcode to the physical component.

It is understood that various embodiments of the present invention may be implemented by the use of software run on various devices, such as mobile computing devices, storage devices, optical scanners, networking components, and/or other computers that may be used to provide user interfaces or other output and/or export functionalities. It is further understood that the present invention is not limited to the use of software to implement the systems or methods of the invention. Other non-limiting examples of ways to implement various embodiments of the invention can include firmware, Read Only Memories (ROMs), Programmable Read Only Memories (PROMs), Electrically Erasable Programmable Read Only Memories (EEPROMs), Application-Specific Integrated Circuits (ASICs) and other hard-wired circuits.

According to the various methods of the invention, the information may optionally include a sound recording, text and/or a photograph or other graphical image. Sound recordings may optionally be processed using voice processing capabilities to convert the voice data into textual data that is instead or in addition to the sound recording, saved to the issue list. The voice processing may optionally be multi-lingual. The information stored may relate to work to be performed on the physical component of the project associated with the barcode affixed to that component. A storage device, including stationary storage devices, may store information such that a user is restricted from accessing at least a portion of the information not related to the user's portion of the project. In addition or alternatively, the storage device may store information such that the user is restricted from accessing and/or modifying at least a portion of the information not related to the user's role in the project.

Various embodiments of the invention may include additional features, such as features described in relation to other embodiments or implementations. Additional features may be provided within the scope of the invention, for example, a user may choose a certain data value from a list of available options and other users may view those options in their native language—the software may support user-level personalization to the users preferred language, currency and locale. Information links between identifiers and an extranet or shared database may enable: harmonization of data; coordination of work; real-time communication between the construction and/or capital project site and any party connected via mobile computing device, via extranet, and/or via the Internet; proactive notification to the responsible party or stakeholder; record locations of physical work via Global Positional System (GPS), General Radio Packet System (GRPS), and Global System for Mobile Communications (GSM); automatic alerts on the status of the work; periodic and/or scheduled updates of the status of the mending of the deficiencies; and a broad spectrum of other beneficial features described herein. Two- and/or three-dimensional digital drawings or “maps” of the site may also be used within the scope of the invention site that identify the physical location in real space of the components of the projects associated with the barcodes.

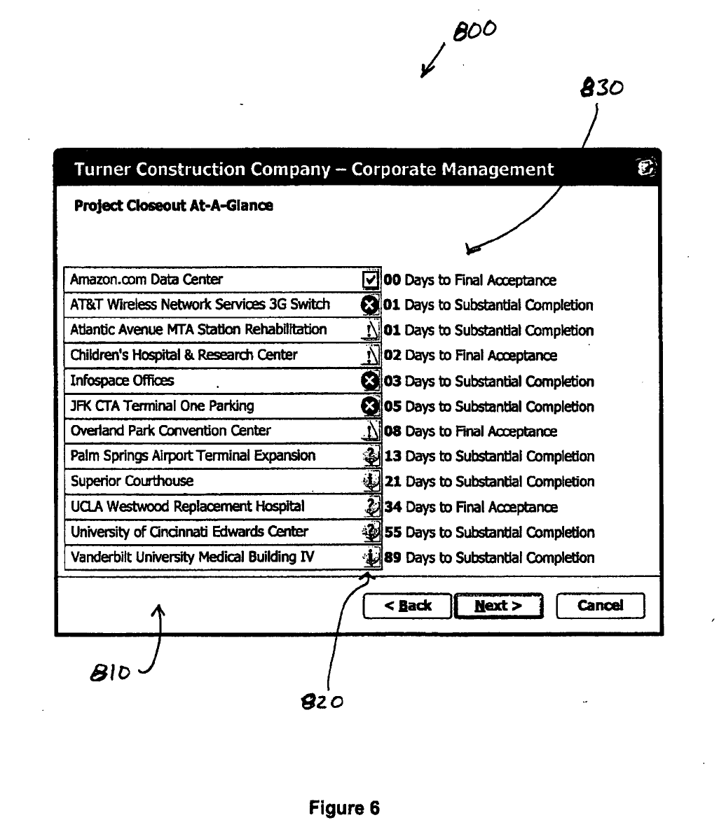

FIG. 6 illustrates an example of a user interface 800 providing a project closeout at a glance. This example illustrates a variety of deficiencies 810, or categories of deficiencies with status icons 820 and indications 830 of days to the next milestone, e.g. substantial completion or final acceptance. This user interface provides a top-level summary of data in the issue list of the example.

The illustrative embodiments, implementations and examples herein are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. The preferred embodiments are merely illustrative and should not be considered restrictive in any way.

What is claimed is:

1. A system for administrating a construction project, the system comprising:
an identifier barcode adapted to be affixed to at least one physical component of a construction project, the physical component of the project having at least one deficiency;
an optical scanner for scanning the barcode;
a storage device storing an issue list, the issue list comprising at least one work item corresponding to the deficiency in the physical component of the project on which the barcode is affixed;
a first user interface to enable a first party to view the at least one work item and indicate completion of an activity corresponding to the at least one work item, thereby signifying closure of the at least one work item; and
a second user interface to enable a second party to view a status of the at least one work item after the first party indicates completion of the activity corresponding to the at least one work item, and either accept or reject the closure of the at least one work item, wherein upon an acceptance or rejection of the at least one work item by the second party, the issue list is updated to reflect the acceptance or rejection of the completion of the at least one work item.

2. The system of claim 1, further comprising: a mobile computing device capable of receiving the identifier from the optical scanner and communicating with the storage device to modify at least one attribute of the at least one work item on the storage device and receive information regarding the issue list, using the identifier received to associate the physical component of the project to a corresponding portion of the issue list.

3. The system of claim 2, wherein the first user interface and the second user interface are presented on the mobile computing device.

4. The system of claim 1, further comprising a third user interface in communication with the storage device and configured to receive information from the issue list, modify the issue list and add items to the issue list.

5. The system of claim 4, wherein the user interface is in communication with the storage device by way of the Internet.

6. A method for administrating a construction project, the method comprising:
affixing a barcode having an identifier to a physical component of a construction project, the physical component of the project having at least one deficiency and corresponding to at least one work item;
scanning the identifier with an optical scanner;
receiving the identifier at a first mobile computing device;
inputting information into the first mobile computing device relating to the deficiency in the physical component of the project, the information being associated with the identifier;
transmitting the information and the identifier from the first mobile computing device to a storage device;
storing the information and identifier in the storage device;
receiving the information and the identifier from the storage device at a second mobile computing device after the first mobile computing device transmits the information and the identifier to the storage device;
transmitting the identifier and an indication that the deficiency has been corrected to the storage device from the second mobile computing device;
receiving the identifier and the indication that the deficiency has been corrected at a third mobile computing device; and
transmitting, from the third mobile computing device, the identifier and an indication that correction of the deficiency has been accepted or rejected, wherein upon acceptance or rejection, the storage device is updated to reflect the acceptance or rejection of the correction of the deficiency.

7. The method of claim 6, wherein the information includes a sound recording.

8. The method of claim 6, wherein the information includes a photograph.

9. The method of claim 6, wherein the information includes a document or drawing.

10. The method of claim 6, wherein the information includes a video recording.

11. The method of claim 6, wherein the information includes a digital signature.

12. The method of claim 6, wherein the information includes a Building Information Model (BIM).

13. A method for administrating a construction project, the method comprising:
affixing a plurality of barcodes each having a unique identifier to a plurality of physical components of a construction project, the physical component of the project having at least one deficiency;
scanner the unique identifier from at least one of the plurality of barcodes with an optical scanner;
receiving at least one unique identifier at a first mobile computing device;
receiving from a stationary storage device, information relating to the deficiency in the physical component of the project and associated with the at least one unique identifier;
displaying on the first mobile computing device, the information relating to each of the at least one unique identifiers received at the first mobile computing device;
inputting the information into the first mobile computing device relating to the deficiency in the physical component of the project and associated with the at least one unique identifier; and
enabling a second mobile computing device to view the information and accept or reject the deficiency after the first mobile computing device indicates the deficiency in the physical component of the facility, wherein upon an acceptance or rejection of the deficiency by the second mobile computing device, the stationary store device is updated to reflect the acceptance or rejection of the deficiency in the physical component of the facility.

14. The method of claim 13, wherein the information relates to work to be performed on the physical component of the project associated with the barcode affixed to the physical component.

15. The method of claim 13, wherein the stationary storage device stores the information such that a user is restricted from accessing at least a portion of the information not related to the user's portion of the construction project.

16. The method of claim 13, wherein the stationary storage device stores the information such that a user is restricted from accessing at least a portion of the information not related to the user's role in the construction project.

17. The method of claim 13, wherein the stationary storage device stores the information such that a user is restricted from modifying at least a portion of the information not related to the user's role in the construction project.

18. A method of administrating a construction project, the method comprising:
associating an identifier of a barcode to a physical component of a construction project, the physical component of the project having at least one deficiency;
creating at least one work item on an issue list, the work item associated with the identifier and related to the deficiency in the physical component of the project;
inputting a first comment corresponding to the at least one work item into a first mobile computing device;
associating the first comment with the identifier;
transmitting the identifier and the first comment from the first mobile computing device to a storage device;
transmitting the identifier and the first comment from the storage device to a second mobile computing device; and
displaying the first comment in relation to an inquiry pertaining to the identifier on the second mobile computing device after the first comment is inputted into the first mobile computing device.

19. The method of claim 18, further comprising:
inputting a second comment corresponding to the at least one work item;
associating the second comment with the identifier; and
displaying the first comment and the second comment in relation to an inquiry pertaining to the identifier.

20. The method of claim 18, further comprising affixing the barcode to the physical component.
